(19) United States
(12) Patent Application Publication
(10) Pub. No.: US 2007/0001634 A1
(43) Pub. Date: Jan. 4, 2007

(54) Bi-directional single-phase fan and motor thereof

(75) Inventors: Chia-Pin Wei, Taoyuan Hsien (TW); Yi-Lun Chen, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/453,021

(22) Filed: Jun. 15, 2006

(30) Foreign Application Priority Data
Jun. 30, 2005 (TW) 094122136

(51) Int. Cl. H02P 7/06

(52) U.S. Cl. 318/254

(57) ABSTRACT

A bi-directional single-phase motor includes a stator, a rotor and a control circuit. The rotor is coupled to the stator and rotates along a first direction or a second direction. The control circuit is disposed in the stator and has a first inductive element and a second inductive element. When the first inductive element is on and the second inductive element is off, the rotor rotates along the first direction. When the first inductive element is off and the second inductive element is on, the rotor rotates along the second direction.

### BACKGROUND OF THE INVENTION

1. Field of Invention

The present invention relates to a fan and a motor thereof, and more particularly, to a bi-directional single-phase fan and a motor thereof.

2. Related Art

As shown in FIG. 1, a conventional single-phase fan 1 has a stator 11, a rotor 12 coupled to the stator 11, and an impeller 13 disposed on the rotor 12. The stator 11 has a first coil 111 and a second coil 112. The rotor 12 has a permanent magnet 121. The impeller 13 has a plurality of blades 131.

The stator 11 further has a Hall element 113 electrically connected to the first coil 111 and the second coil 112 for detecting the pole position of the permanent magnet 121 of the rotor 12.

Moreover, to prevent the single-phase fan 1 from hurting the user during its operation, the inlet and outlet sides of the single-phase fan 1 are respectively added with an air filter (not shown).

The single-phase fan 1 is currently, designed to provide airflow in a single direction because one has to take into account the position of the Hall element 113 in the stator 11. Generally speaking, for the smooth rotation of the rotor 12 to produce higher efficiency, the Hall element 113 must be disposed at a best position for detection. However, if the rotating direction of the rotor 12 is changed, the Hall element 113 cannot correctly detect the poles of the rotor 12. This will result in the erroneous adjustment of the inductive poles of the first coil 111 or the second coil 112 by the control circuit and irregular rotation of the rotor 12. The single-phase fan 1 may not even rotation. Therefore, the single-phase fan in the prior art can only provide airflow in single direction.

Moreover, if the conventional single-phase fan is installed with air filters, the dust is accumulated on the air filters after the fan operating for a period of time. This will reduce the operation efficiency, increase the noise during operation, and shorten the lifetime of the fan.

It is thus imperative to provide a bi-directional single-phase fan and a motor thereof to solve the above-mentioned problems.

### SUMMARY OF THE INVENTION

In view of the foregoing, the present invention provides a bi-directional fan and a motor thereof. The fan has good efficiency for the airflow in either rotating direction. By changing the airflow direction, the fan can automatically clear the dusts on the blades or air filter, maintaining good airflow efficiency, low operation noise, and long lifetime.

To achieve the above, a bi-directional single-phase motor according to the present invention includes a stator, a rotor and a control circuit. The rotor is coupled to the stator. The control circuit is disposed in the stator and has a first inductive element and a second inductive element. When the first inductive element is on and the second inductive element is off, the rotor rotates along a first direction. When the first inductive element is off and the second inductive element is on, the rotor rotates along a second direction.

To achieve the above, a bi-directional single-phase fan according to the present invention includes a stator, a rotor, a control circuit and an impeller. The rotor is coupled to the stator. The control circuit is disposed in the stator and has a first inductive element and a second inductive element. When the first inductive element is on and the second inductive element is off, the rotor rotates along a first direction. When the first inductive element is off and the second inductive element is on, the rotor rotates along a second direction. The impeller is connected to rotor.

In the above-mentioned fan and motor, a delay unit can be added to connect with the control circuit, preventing the fan from damaging the control circuit caused by the short current formed while the fan changes its rotating direction.

As mentioned above, a bi-directional single-phase fan and a motor thereof according to the present invention can provide either forward or backward airflow in accordance with needs. The first inductive element and the second inductive element can be switched on and off according to the rotating direction. Therefore, they can correctly detect the magnetism of the magnetic poles of the rotor. Comparing with the prior art, the present invention can maintain good airflow efficiency in either rotating direction of the rotor. Moreover, the design of the delay unit can prevent a short current from happening when the fan changes its rotating direction, ensuring safer usage of the fan. Besides, the present invention can clean the dusts on the blades or air filter by changing the airflow direction of the fan.

### BRIEF DESCRIPTION OF THE DRAWINGS

The present invention will become more fully understood from the detailed description given herein below illustration only, and thus are not limitative of the present invention, and wherein:

FIG. 1 is a schematic view of a conventional single-phase motor,

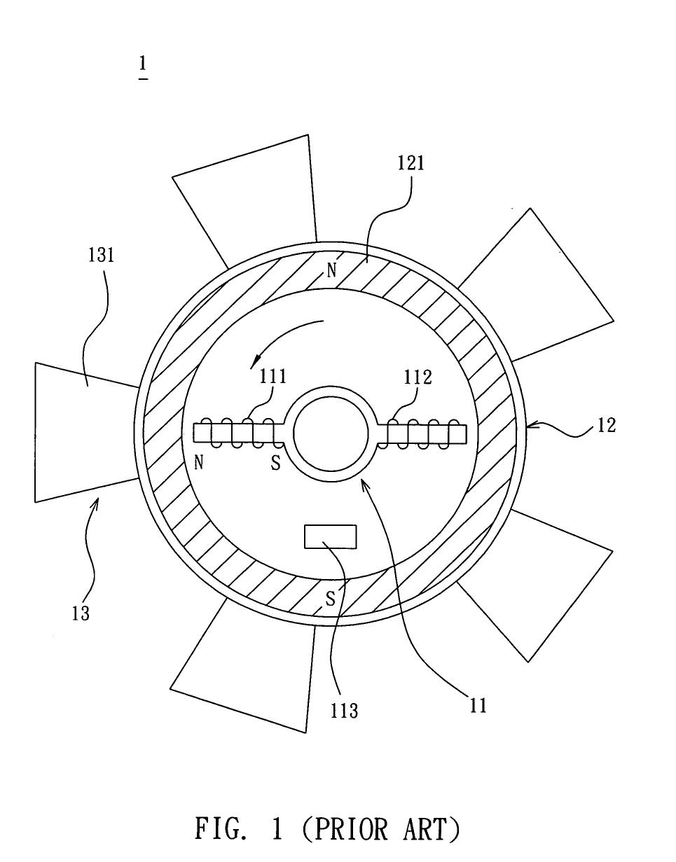

FIG. 2 is a schematic view of a bi-directional single-phase fan and a motor thereof according to a preferred embodiment of the present invention; and

FIG. 3 is a schematic view of the control circuit according to a preferred embodiment of the present invention.

### DETAILED DESCRIPTION OF THE INVENTION

The present invention will be apparent from the following detailed description, which proceeds with reference to the accompanying drawings, wherein the same references relate to the same elements.

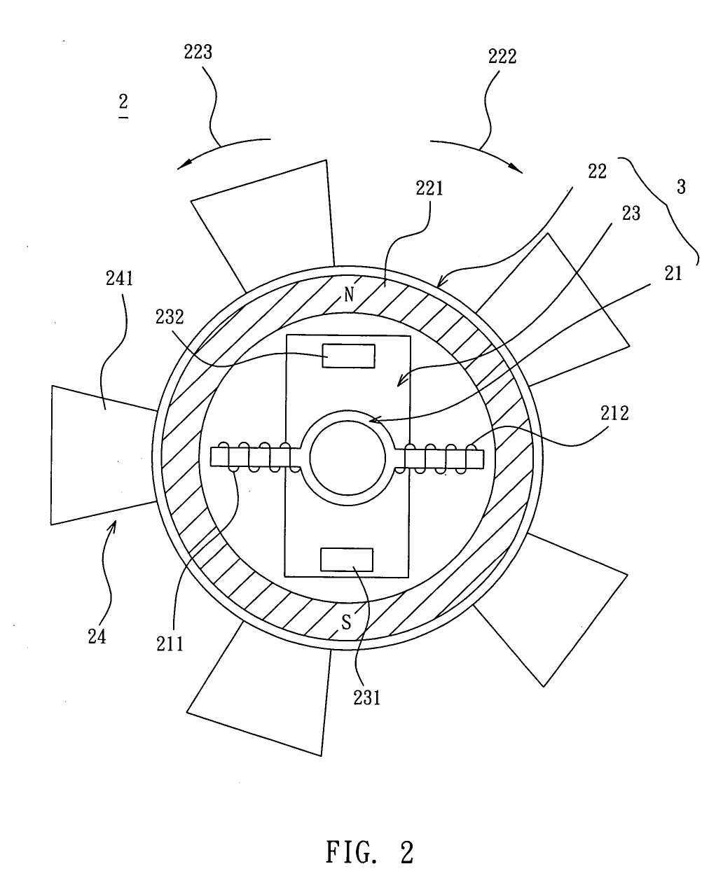

As shown in FIG. 2, a bi-directional single-phase fan 2 according to the present invention includes a stator 21, a rotor 22, a control circuit 23 and an impeller 24. The stator 21, the rotor 22 and the control circuit 23 constitute a single-phase motor 3.

The stator 21 has a first coil 211 and a second coil 212 as the magnetic poles of the stator 21.

The rotor 22 has a permanent magnet 221 coupled to the stator 21. Due to the variation of the magnetic forces among the first coil 211, the second coil 212 and the permanent magnet 221, the rotor 22 rotates along a first direction 222 or a second direction 223 with respect to the stator 21.

The control circuit 23 is disposed in the stator 21 and has a first inductive element 231 and a second inductive element 232. In this embodiment, the first inductive element 231 and the second inductive element 232 may be Hall elements, and the first inductive element 231 and the second inductive element 232 can detect the magnetic pole positions of the rotor 22. When the first inductive element 231 is on and the second inductive element 232 is off, the rotor 22 rotates along the first direction 222. When the second inductive element 232 is on and the first inductive element 231 is off, the rotor 22 rotates along the second direction 223.

The impeller 24 is connected to the rotor 22 and has a plurality of blades 241. In this embodiment, each blade 241 of the impeller 24 preferably has an axially symmetric shape. More explicitly, the blade 241 includes but not limited to a flat-plate or trapezoid blade. If each blade 241 has an axially symmetric shape, the fan possesses good efficiency in providing airflow in either direction. When the rotor 22 rotates along the first direction 222, the airflow direction of the impeller 24 is forward. When the rotor 22 rotates along the second direction 223, the airflow direction of the impeller 24 is backward. Of course, using different designs of the blade structure in the impeller, the fan can provide backward airflow as the rotor rotates along the first direction and forward airflow as the rotor rotates along the second direction.

The fan 2 may be cooperated with an air filter (not shown). The air filter can prevent external dusts or impurities from entering the fan 2. It also prevents the user from touching the interior of the fan 2 and damaging the user or the fan 2. Therefore, the air filter ensures an effective operation of the fan 2.

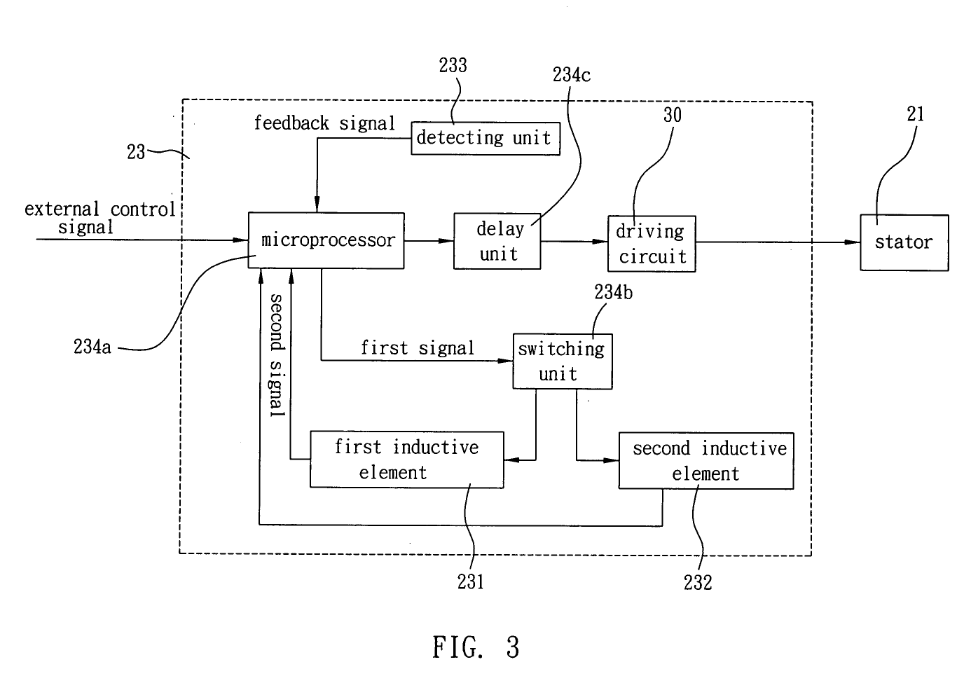

As shown in FIG. 3, the control circuit 23 further includes a detecting unit 233, a microprocessor 234a, a switching unit 234b, a driving circuit 30 and a delay unit 234c.

The detecting unit 233 automatically detects the temperature, moisture or pressure of the environment surrounding the fan 2 and generates a feedback signal. The control circuit 23 receives an external control signal or the feedback signal generated by the detecting unit 233 to adjust the magnetism of the magnetic poles of the stator 21. The control circuit 23 also controls the rotor 22 to rotate along the first direction 222 or the second direction 223 by the adjustment.

The microprocessor 234a receives the external control signal or the feedback signal and generates a first signal. It also receives a second signal from the first inductive element 231 or the second inductive element 232, and outputs a third signal to the driving circuit 30 to change the inductive magnetism of the first coil 211 and the second coil 212; thereby controlling the rotating direction and speed of the rotor 22.

The switching unit 234b receives the first signal and selectively turns the first inductive element 231 or the second inductive element 232 on. The first inductive element 231 or the second inductive element 232 detects the rotational result of the rotor 22, and generates and outputs the second signal to the microprocessor 234a.

The first inductive element 231 and the second inductive element 232 are respectively disposed at the best detecting positions for the fan 2 rotating along the forward and the backward directions. The first inductive element 231 and the second inductive element 232 may be Hall elements. In this embodiment, only one of the first inductive element 231 and the second inductive element 232 is switched on, depending upon whether the fan 2 is rotating forward or backward. The on and off of the inductive elements may be controlled by the control circuit, the microprocessor, or be manually controlled.

The driving circuit 30 is electrically connected to the microprocessor 234a and the stator 21 to adjust the current and voltage on the first coil 211 and the second coil 212. This in turn controls the magnetism and the field strength of the magnetic poles of the stator 21.

The delay unit 234c is disposed between the microprocessor 234a and the driving circuit 30 to temporarily delay the electrical current from the microprocessor 234a or the driving circuit 30. This prevents the microprocessor 234a or the driving circuit 30 from being burnt out by the electrical current produced when the fan 2 changes its rotating direction.

The bi-directional fan 2 can change the rotating direction of the rotor 22 according to practical needs, thereby changing the airflow direction of the fan 2. Comparing with the prior art, the fan 2 has inductive elements at the best detecting positions for both the forward and backward rotations. Therefore, the efficiency of the fan 2 is not reduced when the rotor 22 changes its rotating direction. Besides, the impeller 24 or the air filter is likely to accumulate some dusts after operating a period of time, and the bi-directional fan 2 can remove them by changing the airflow direction.

In summary, a bi-directional single-phase fan and a motor thereof according to the present invention can provide either forward or backward airflow in accordance with needs. The first inductive element and the second inductive element can be switched on and off according to the rotating direction. Therefore, they can correctly detect the magnetism of the magnetic poles of the rotor. Comparing with the prior art, the present invention can maintain good airflow efficiency in either rotating direction of the rotor. Moreover, the design of the delay unit can prevent a short current from happening when the fan changes its rotating direction, ensuring safer usage of the fan. Besides, the present invention can clean the dusts on the blades or air filter by changing the airflow direction of the fan.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A bi-directional single-phase motor, comprising:
a stator,
a rotor coupled to the stator, and
a control circuit disposed in the stator and has a first inductive element and a second inductive element;
wherein the rotor rotates along a first direction when the first inductive element is on and the second inductive element is off, and the rotor rotates along a second direction when the first inductive element is off and the second inductive element is on.

2. The bi-directional single-phase motor according to claim 1, wherein the control circuit further comprises a detecting unit for detecting a temperature or pressure of external environment and generating a feedback signal.

3. The bi-directional single-phase motor according to claim 2, wherein the control circuit further comprises:
a microprocessor for receiving an external control signal or the feedback signal and generating a first signal;
a switching unit for receiving the first signal and switching on/off the first inductive element or the second inductive element; and
a driving circuit electrically connected to the microprocessor and the stator for controlling the magnetism and the magnetic field strength of the magnetic poles of the stator.

4. The bi-directional single-phase motor according to claim 1, wherein the control circuit further comprises:
a microprocessor for receiving an external control signal and generating a first signal;
a switching unit for receiving the first signal and switching on/off the first inductive element or the second inductive element; and
a driving circuit electrically connected to the microprocessor and the stator for controlling the magnetism and the magnetic field strength of the magnetic poles of the stator.

5. The bi-directional single-phase motor according to claim 4, wherein the first inductive element or the second inductive element generates and outputs a second signal to the microprocessor according to the result of detecting the rotation of the rotor.

6. The bi-directional single-phase motor according to claim 4, wherein the control circuit further comprises a delay unit disposed between the microprocessor and the driving circuit for temporarily delaying an electrical current from the microprocessor or the driving circuit.

7. The bi-directional single-phase motor according to claim 1, wherein the on and off of the first inductive element and the second inductive element are manually controlled.

8. The bi-directional single-phase motor according to claim 1, wherein the on and off of the first inductive element and the second inductive element are controlled by the control circuit or a microprocessor.

9. The bi-directional single-phase motor according to claim 1, wherein the first inductive element or the second inductive element is a Hall element.

10. A bi-directional single-phase fan, comprising:
a stator;
a rotor coupled to the stator;
a control circuit disposed in the stator and has a first inductive element and a second inductive element, wherein the rotor rotates along a first direction when the first inductive element is on and the second inductive element is off, and the rotor rotates along a second direction when the first inductive element is off and the second inductive element is on; and
an impeller connected to the rotor.

11. The bi-directional single-phase fan according to claim 10, wherein the control circuit further comprises a detecting unit for detecting a temperature or pressure of external environment and generating a feedback signal accordingly.

12. The bi-directional single-phase fan according to claim 11, wherein the control circuit further comprises:
a microprocessor for receiving an external control signal or the feedback signal and generating a first signal;
a switching unit for receiving the first signal and switching on/off the first inductive element or the second inductive element; and
a driving circuit electrically connected to the microprocessor and the stator for controlling the magnetism and the magnetic field strength of the magnetic poles of the stator.

13. The bi-directional single-phase fan according to claim 10, wherein the control circuit further comprises:
a microprocessor for receiving an external control signal and generating a first signal;
a switching unit for receiving the first signal and switching on/off the first inductive element or the second inductive element; and
a driving circuit electrically connected to the microprocessor and the stator for controlling the magnetism and the magnetic field strength of the magnetic poles of the stator.

14. The bi-directional single-phase fan according to claim 13, wherein the first inductive element or the second inductive element generates and outputs a second signal to the microprocessor according to the result of detecting the rotation of the rotor.

15. The bi-directional single-phase fan according to claim 13, wherein the control circuit further comprises a delay unit disposed between the microprocessor and the driving circuit for temporarily delaying an electrical current from the microprocessor or the driving circuit.

16. The bi-directional single-phase fan according to claim 10, wherein the on and off of the first inductive element and the second inductive element are manually controlled.

17. The bi-directional single-phase fan according to claim 10, wherein the on and off of the first inductive element and the second inductive element are controlled by the control circuit or a microprocessor.

18. The bi-directional single-phase fan according to claim 10, wherein the first inductive element or the second inductive element is a Hall element.

19. The bi-directional single-phase fan according to claim 10, wherein the shape of each blade of the impeller is axially symmetric.

20. The bi-directional single-phase fan according to claim 10, wherein the shape of each blade of the impeller is flat-plate or trapezoid.
